(19) United States
(12) Patent Application Publication
(10) Pub. No.: US 2026/0217035 A1
(43) Pub. Date: Jul. 30, 2026

(54) INK-JET RECORDING APPARATUS

(71) Applicant: BROTHER KOGYO KABUSHIKI KAISHA, Nagoya (JP)

(72) Inventor: Takashi ISHIDA, Nagoya (JP)

(73) Assignee: BROTHER KOGYO KABUSHIKI KAISHA, Nagoya (JP)

(21) Appl. No.: 19/629,087

(22) Filed: Mar. 26, 2026

Related U.S. Application Data
(63) Continuation of application No. PCT/JP2025/001761, filed on Jan. 21, 2025.

(30) Foreign Application Priority Data
Jan. 31, 2024 (JP) 2024-013270

(51) Int. Cl. B41J 2/175; B41J 2/18; B41J 2/19

(52) U.S. Cl. CPC B41J 2/17596; B41J 2/18; B41J 2/19

(57) ABSTRACT

An inkjet recording apparatus 1 includes: a deaerator 30 for deaerating ink I flowing in a second flow passage 92; and a circulation pump 62 for applying pressure to a circulation path of the ink I including a sub-tank 52, the second flow passage 92, the deaerator 30, a third flow passage 93, a head 11, and a fourth flow passage 94, to generate an ink flow of the ink I in the circulation path. The deaerator 30 has an ink inlet 12A and an ink outlet 12B, and the ink inlet 12A is arranged at a position closer to the head 11 than the ink outlet 12B in a direction in which the ink I is ejected from a nozzle row 16.

### REFERENCE TO RELATED APPLICATIONS

This application is a Continuation Application of International Application No. PCT/JP2025/001761 filed on January 21, 2025 that claims the conventional priority of Japanese patent Application No. 2024-013270 filed on January 31, 2024. The entire content of Japanese patent Application No. 2024-013270 and the entire content of International Application No. PCT/JP2025/001761 are incorporated herein by reference.

### BACKGROUND ART

A known ink supply apparatus includes: a main tank in which ink is stored; a first flow passage through which the ink flows from the main tank; a sub-tank temporarily stores ink from the first flow passage and adjusts pressure of the ink; a second flow passage through which the ink flows from the sub-tank; a head section ejecting the ink supplied from the second flow passage; a deaerator installed in a part of a path from the main tank to the head section; and a return flow passage to return the ink downstream of the sub-tank to the sub-tank.

### SUMMARY

### Technical Problem

However, in the ink supply apparatus described above, the positional relationship between the head section and the deaerator is not clearly defined, and depending on the environment in which the apparatus is used, the ink path may be divided inside the deaerator during ink filling, causing problems with ink supply. In addition, since the sub-tank is disposed downstream of the deaerator in the path to the head unit, it took time for the ink deaerated by the deaerator to reach the head unit, and the initial printing from the state of not printing to the state of printing could take time.

An object of this application is to provide a technology that will make it possible to further reduce the initial printing time.

### Solution to the Problem

To achieve the above-mentioned object, the inkjet recording apparatus of this application includes: a head having a nozzle row configured to eject ink;

a main tank configured to store the ink;

a first flow passage through which the ink flows from the main tank;

a sub-tank connected to the first flow passage and configured to temporarily store the ink flowing in the first flow passage;

a second flow passage through which the ink flows from the sub-tank;

a deaerator connected to the second flow passage and configured to deaerate the ink flowing in the second flow passage;

a third flow passage through which the ink deaerated by the deaerator flows to the head;

a fourth flow passage connecting the head and the sub-tank, the ink being returned from the head to the sub-tank through the fourth flow passage;

a circulation pump configured to apply pressure to the ink in a circulation flow passage including the sub-tank, the second flow passage, the deaerator, the third flow passage, the head, and the fourth flow passage, to generate an ink flow of the ink in the circulation flow passage; and

a damper disposed in the fourth flow passage to control fluctuations in pressure applied to the head,

wherein the deaerator has an ink inlet and an ink outlet, and

the ink inlet is arranged closer to the head than the ink outlet in a direction in which the ink is ejected from the nozzle row.

### Effect of the invention

According to this application, the deaerator is arranged at a position downstream of the sub-tank and closer to the head, such that the ink amount on the flow path connecting the deaerator and the head is reduced. Therefore, the time for the ink deaerated by the deaerator to reach the head is shortened, and the initial printing time from the state of not printing to the state of printing can be further shortened. In addition, since the deaerator is arranged such that the ink inlet thereof is closer to the head than the ink outlet in a direction in which the ink is ejected from the nozzle row, separation of the ink path inside the deaerator is suppressed during ink filling, thereby reducing ink supply problems.

### BRIEF DESCRIPTION OF DRAWINGS

FIG. 1 depicts a control configuration of an inkjet recording apparatus according to one embodiment of the application.

FIG. 2 is a perspective view depicting an appearance of a head unit included in the inkjet recording apparatus of FIG. 1.

FIG. 3 is a perspective view depicting a state where the cover section is removed from the head unit in FIG. 2.

FIG. 4 is a right side view of the head unit in FIG. 3.

FIG. 5 is a bottom view of the head unit in FIG. 3.

### DESCRIPTION

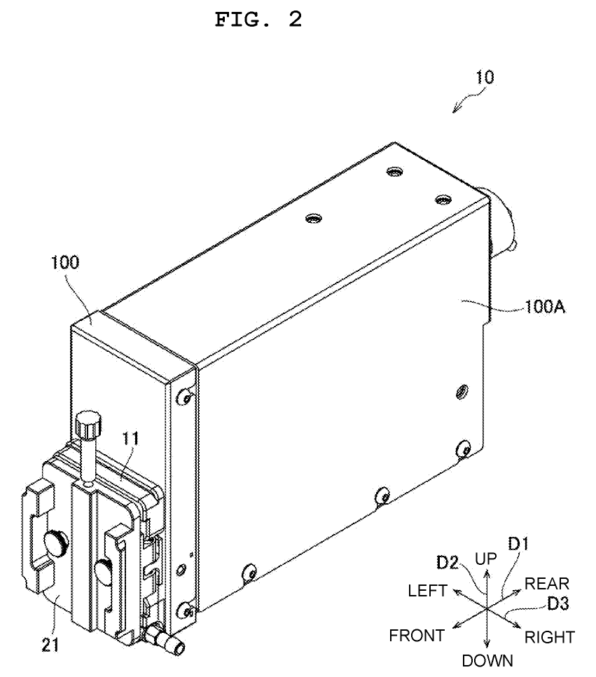

The following is a detailed description of the embodiments of the present application based on the drawings. In the drawings used for the following explanation, some of the basic configurations may be omitted, and the dimensional ratios, etc. of the depicted parts are not necessarily accurate. In FIGS. 2 through 5, the front-rear direction D1, up-down direction D2, and left-right direction D3 are as described in the respective figures.

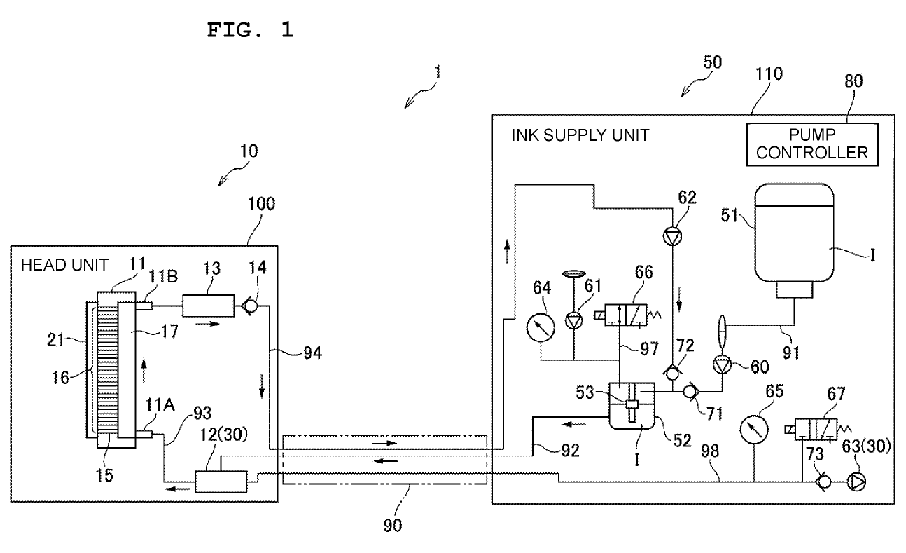

FIG. 1 depicts a control configuration of an inkjet recording apparatus 1 in accordance with one embodiment of the present application. As depicted in FIG. 1, the inkjet recording apparatus 1 is primarily configured with a head unit 10 and an ink supply unit 50. The head unit 10 and the ink supply unit 50 are connected via a cable 90.

The head unit 10 includes a box-shaped head unit housing 100 (see FIG. 2 for its specific shape), a head 11 for ejecting ink, a deaeration module 12 that deaerates dissolved gas contained in the ink to be supplied to the head 11, a damper 13 for suppressing pressure fluctuations to be applied to the head 11 and a check valve 14. The head unit housing 100 contains the head 11, the deaeration module 12, the damper 13, and the check valve 14.

The head 11 has a nozzle row 16 in which a plurality of nozzles 15 for ejecting the ink is arranged in an up-down direction, and an ink reservoir 17 that is connected to the nozzle row 16 and stores the ink to be ejected from each of the nozzles 15. Since the nozzle row 16 consists of two rows in this embodiment, for example, one ink reservoir 17 is also provided for each of the two nozzle rows 16. An ink inlet 11A is provided at the bottom of each ink reservoir 17, and an ink outlet 11B is provided at the top of each ink reservoir 17. The number of nozzle rows 16 is not limited to two, but can be one or three or more. The number of ink reservoirs 17 should also be in proportion to the number of nozzle rows 16. Even if the number of rows is multiple, one ink reservoir 17 may be used to provide the ink. The number of the ink inlet 11A and the ink outlet 11B should also correspond to the number of ink reservoirs 17.

A nozzle protection cap 21 is removably attached to the head 11 to protect the nozzle row 16 from external shocks and dust adhesion. In this embodiment, UV ink, for example, which is an ultraviolet-curable type ink, is used as the ink to be ejected from the head 11. Therefore, the nozzle protection cap 21 is attached to cover the area around the nozzle rows 16 when printing is not being performed, so that the UV ink is not exposed to external light, including ultraviolet rays, through the nozzle rows 16. The UV ink has a property that oxygen and other gases in the air dissolve in the ink if the UV ink is left in contact with air for a long time. The more dissolved gases in the ink, the more the print quality deteriorates, and the more time is required for a process to deaerate the dissolved gases. For this reason, the nozzle protection cap 21 also functions to keep the ink in the nozzle row 16 from coming into contact with air as much as possible when printing is not being performed.

The deaeration module 12, for example, has a plurality of hollow fibers and removes dissolved gases in the ink by passing ink through each hollow fiber and depressurizing the outside of each hollow fiber. The method of removing dissolved gas in the ink is not limited to this, and other methods may be employed, such as passing ink through the outside of each hollow fiber and depressurizing the inside of each hollow fiber to remove dissolved gas in the ink. In short, any method may be adopted for the deaeration module 12 as long as it can remove dissolved gases in the ink, but the deaeration module 12 must be small enough to be accommodated in the head unit 10.

The ink supply unit 50 has a box-shaped ink supply unit housing 110 (specific shape is not depicted) which contains a main tank 51 that stores ink I, a sub-tank 52 that temporarily stores the ink I supplied from the main tank 51, four pumps 60-63, two pressure gauges 64, 65, two valves 66, 67, three check valves 71-73, and a pump controller 80 that controls the drive of each of the pumps 61-64.

The pump controller 80 is configured, for example, with a CPU, a ROM, and a RAM, etc. The CPU controls each of the pumps 60-63 and each of the valves 66, 67 by executing the pump control program stored in the ROM. The RAM stores data when executing the pump control program, and stores results of calculations.

The main tank 51 consists of, for example, a pouch-wrapped container ("pouch"), which can be replaced with a new pouch when the ink I in the pouch runs out. The main tank 51 is connected to the sub-tank 52 via a first flow passage 91 for supplying the ink I in the main tank 51 to the sub-tank 52. The first flow passage 91 is provided with a supplying pump 60 that executes supplying of the ink I from the main tank 51 to the sub-tank 52 and a first check valve 71 to prevent backflow, which is the flow of the ink I in a direction opposite to the supplying direction. The first flow passage 91 is formed, for example, by a flexible pipe. The second through fourth flow passages 92-94, described below, are also formed in the same manner as the first flow passage 91, e.g., by flexible pipes.

The sub-tank 52 is a tank for temporarily storing the ink I supplied from the main tank 51 as described above, and has a storage amount detection sensor 53 for detecting storage amount of the ink I in the sub-tank 52. The storage amount detection sensor 53 is, for example, a float sensor, which outputs an ON signal when the liquid level of the ink I in the sub-tank 52 reaches a predetermined upper limit position and outputs an OFF signal when that the liquid level of the ink I reaches a predetermined lower limit position. Once the storage amount detection sensor 53 outputs the ON signal, the storage amount detection sensor 53 continuously outputs the ON signal until the storage amount detection sensor 53 outputs the OFF signal. Once the storage amount detection sensor 53 outputs the OFF signal, the storage amount detection sensor 53 continuously outputs the OFF signal until the storage amount detection sensor 53 outputs the ON signal.

Therefore, the pump controller 80 can determine that the liquid level of the ink I in the sub-tank 52 has reached the upper limit position when the detection signal outputted from the storage amount detection sensor 53 switches from the OFF signal to the ON signal, and when the detection signal outputted from the storage amount detection sensor 53 switches from the ON signal to the OFF signal, the pump controller 80 can determine that the liquid level of the ink I in the sub-tank 52 has reached the lower limit position. Therefore, the pump controller 80 starts driving the supplying pump 60 when the pump controller 80 determines that the liquid level of the ink I has reached the lower limit position, and stops driving the supplying pump 60 when the pump controller 80 determines that the liquid level of the ink I has reached the upper limit position, thereby controlling storage amount of the ink I in the sub-tank 52 within a range from a predetermined upper limit amount to a predetermined lower limit amount.

The sub-tank 52 is connected to the deaeration module 12 in the head unit 10 via a second flow passage 92 for supplying the ink I in the sub-tank 52. One end of a positive pressure path 97 is connected to the sub-tank 52 to apply positive pressure to an inside of the sub-tank 52, and a solenoid valve 66 for the sub-tank 52 is connected to the other end of the positive pressure path 97. This solenoid valve 66 is hereinafter referred to as a sub-tank valve 66.

The sub-tank valve 66 switches the valve between a closed state and an open states in response to an ON/OFF signal from the pump controller 80. The sub-tank valve 66, for example, is always open. The sub-tank valve 66 switches the valve to the closed state when the ON signal is output from the pump controller 80, and switches the valve to the open state when the OFF signal is output from the pump controller 80.

The air pump 61 and the pressure gauge 64 are connected to the positive pressure path 97. When the inkjet recording apparatus 1 receives a maintenance command such as initial ink introduction or purging operation, the air pump 61 pressurizes the inside of the sub-tank 52 via the positive pressure passage 97 and supplies the ink I in the sub-tank 52 to the head 11 through the second flow passage 92, the deaeration module 12, and a third flow passage 93. The pressure gauge 64 detects the pressure in the sub-tank 52 through the positive pressure path 97 and outputs a detection result to the pump controller section 80. During the initial introduction of ink, the pump controller 80 outputs the ON signal to sub-tank valve 66 to close sub-tank valve 66 and then drives the air pump 61 and the circulation pump 62. The pump controller 80 then controls the drive of the air pump 61 so that the pressure value in the sub-tank 52 detected by the pressure gauge 64 becomes a predetermined pressurization value. As a result, the ink I is supplied from the sub-tank 52 to the head 11 via the deaeration module 12 at a predetermined flow velocity. Furthermore, the air pump 61 and the circulation pump 62 are driven until the ink I flows from the head 11 through the damper 13 and the fourth ink flow passage 94 to sub-tank 52, and then, the air pump 61 and the circulation pump 62 are turned off together with the sub-tank valve 66. During the purge operation, the pump controller 80 outputs the ON signal to the sub-tank valve 66 while the circulation pump 62 remains off, and then, with the sub-tank valve 66 closed, controls the driving of the air pump 61 so that the pressure value in the sub-tank 52 detected by the pressure gauge 64 becomes the predetermined pressure value. As a result, the ink I is pressurized from the sub-tank 52 to the head 11 and is forcibly ejected from the nozzle row 16. After the purge operation, the air pump 61 and the sub-tank valve 66 are turned off.

The deaeration module 12 is connected to the ink inlet 11A of the head 11 via the third flow passage 93 through which the ink I that has been deaerated by the deaeration module 12 flows. Since the inside of the deaeration module 12 needs to be depressurized as described above, the negative pressure pump 63 is connected to the deaeration module 12 via a negative pressure path 98. The pressure gauge 65, the solenoid valve 67, and the third check valve 73 are connected to the negative pressure path 98. The deaeration module 12 and the negative pressure pump 63 and the like configure the deaerator 30.

The solenoid valve 67 switches the valve between an open state and a closed state in response to an ON/OFF signal from the pump controller 80. The solenoid valve 67, for example, is always closed. The solenoid valve 67 switches the valve to the open state when the ON signal is output from the pump controller 80, and switches the valve to the closed state when the OFF signal is output from the pump controller 80.

The pressure gauge 65 detects the pressure value applied to the deaeration module 12 via the negative pressure path 98 and outputs the value to the pump controller 80. The pump controller 80 controls the driving of the negative pressure pump 63 so that the pressure value detected by the pressure gauge 65 becomes the predetermined negative pressure value. The solenoid valve 67 is always closed, as described above, unless the pump controller 80 outputs the ON signal to the solenoid valve 67. The pump controller 80 stops driving the negative pressure pump 63 when the pressure value detected by the pressure gauge 65 reaches the predetermined negative pressure value. The third check valve 73 operates to hold the negative pressure value in the negative pressure path 98, thus stopping the drive of the negative pressure pump 63. When the negative pressure value in the negative pressure path 98 falls to or below a predetermined threshold value, the pump controller 80 resumes driving the negative pressure pump 63. In this way, the negative pressure in the negative pressure path 98 is controlled to a constant value during the deaeration of the ink I by the deaeration module 12.

The ink outlet 11B of the head 11 and the sub-tank 52 in the ink supply unit 50 are connected via the fourth flow passage 94 for returning the ink I that has flowed out of the head 11 to the sub-tank 52. The fourth flow passage 94 is provided with the damper 13, the check valve 14, the circulation pump 62, and the second check valve 72 in this order in the direction that the ink I returns to the sub-tank 52. The sub-tank 52, the second flow passage 92, the deaeration module 12, the third flow passage 93, the head 11, and the fourth flow passage 94 form circulation path of the ink I. The second flow passage 92, the fourth flow passage 94, and the negative pressure path 98 connect the head unit housing 100 and the ink supply unit housing 110 through the above cable 90. When a situation arises in which the ink I stagnant in the circulation path contains a large amount of dissolved gas, such as when a predetermined period of time has elapsed during which the ink I is not ejected from the head 11, the pump controller 80 drives the circulation pump 62 to return the ink I stagnant in the circulation path to the sub-tank 52. At that time, by circulating the ink with the deaerator 30 driven, the ink in the head 11 is replaced by properly deaerated ink that has passed through the deaeration module 12. Then, the ink I that returns to the sub-tank 52 and contains a lot of dissolved gas is also deaerated through the deaeration module 12. Therefore, when the ink I is ejected from the head 11 and printed, the appropriate ink is used. This makes it possible to suppress deterioration of printing quality while reducing waste of the ink I that is retained in the circulation path. The head unit housing 100 is an example of the "first housing" and the ink supply unit housing 110 is an example of the "second housing".

A control process executed by the inkjet recording apparatus 1 configured as described above, in particular executed by the pump controller 80 will be described separately as a print-time process and a circulation-time process. For simplicity of explanation, it is assumed that the inkjet recording apparatus 1 described below has already completed the initial introduction of the ink I. Here, the print-time process refers to a process of printing by ejecting the ink I from the head 11 onto the recording medium, and the circulation-time process refers to a process of circulating the ink I in the above circulation path and returning it to the sub-tank 52. A trigger for starting the print-time process can be, for example, the user's instruction to start printing. On the other hand, the timing for starting the circulation-time process can be, for example, a predetermined timing before starting the print-time process. The predetermined timing includes the timing when the power of the inkjet recording apparatus 1 is turned on, the timing when the user indicates the start of the circulation-time process, and the timing when the predetermined conditions are met. The predetermined conditions include the fact that a predetermined period of time has elapsed during which the ink I is not ejected from the head 11, as described above. Therefore, even if the user indicates the start of printing, if the above predetermined timing is met, the pump controller 80 does not immediately start the print-time process, but starts the print-time process after the completion of the circulation-time process.

When the print-time process is started, the pump controller 80 starts driving the negative pressure pump 63. At this time, it is necessary to close the solenoid valve 67. Since the solenoid valve 67 is always closed, the pump controller 80 does not need to output any signal to the solenoid valve 67. However, when on the ON signal is output to the solenoid valve 67 and the solenoid valve 67 is in the open state, the pump controller 80 needs to output the OFF signal to the solenoid valve 67. The pump controller 80 continues to drive the negative pressure pump 63 until the pressure gauge 65 detects a predetermined negative pressure value, and when the pressure gauge 65 detects the predetermined negative pressure value, the pump controller 80 stops driving the negative pressure pump 63.

Next, when no ink I is stored in the sub-tank 52, the pump controller 80 starts driving the supplying pump 60. Then, when the pump controller 80 detects that the signal output from the storage amount detection sensor 53 has switched from an OFF signal to an ON signal, the pump controller 80 stops driving the supplying pump 60. On the other hand, when ink I is stored in the sub-tank 52, the pump controller 80 controls the storage amount of the ink I in the sub-tank 52 within the range from the predetermined upper limit to the predetermined lower limit as described above.

When the print command signal is received and the head 11 is driven, the ink I is ejected from each of the nozzles 15 forming the nozzle row 16 to execute printing. At this time, the damper 13 suppresses fluctuations in the pressure applied to the head 11. During the execution of the print-time process, the pump controller 80 controls the drive of the circulation pump 62 to the stopped state. The ink amount consumed by driving of the head 11 is replenished from the sub-tank 52 through the second flow passage 92 and the deaeration module 12 by the negative pressure generated by the ink consumption. Thus, during the printing operation, the appropriate ink is supplied through the deaeration module 12 to obtain good quality printing results.

On the other hand, when the circulation-time process is started, the pump controller 80 starts driving the negative pressure pump 63 in the same way as when the print-time process is started. Then, the pump controller 80 causes the negative pressure pump 63 to continue driving until the pressure gauge 65 detects the predetermined negative pressure value, and when the pressure gauge 65 detects the predetermined negative pressure value, the pump controller 80 stops driving the negative pressure pump 63. At this time, the solenoid valve 67 is closed as described above, and the third check valve 73 operates to maintain the negative pressure value in the negative pressure path 98 as described above, so the negative pressure path 98 is maintained at the predetermined negative pressure value.

Next, the pump controller 80 starts driving the circulation pump 62. Assuming that the ink I is stored in the sub-tank 52, the circulation pump 62 is driven to return the ink I in the circulation path to the sub-tank 52. The ink I containing dissolved gas stays in the third flow passage 93 and the ink storage section 17 in the circulation path. This is because during the execution of the print-time process, the ink I is not supplied to the fourth flow passage 94 since the circulation pump 62 is controlled to be stopped as described above. Therefore, if the ink I is returned to the sub-tank 52 by the amount in the third flow passage 93 and the ink reservoir 17, the third flow passage 93 and the ink reservoir 17 will be filled with the ink I deaerated by the deaeration module 12. However, with a margin of error, a maximum of 1.2 times the amount of the ink I in the third flow passage 93 and the ink reservoir 17 may be returned.

Thus, when 1 to 1.2 times the amount of the ink I in the third flow passage 93 and the ink reservoir 17 returns to the sub-tank 52, the pump controller 80 stops the drive of the circulation pump 62. Here, the pump controller 80 can determine whether or not 1 to 1.2 times the amount of the ink I in the third flow passage 93 and the ink reservoir 17 has returned to the sub-tank 52 based on, for example, the drive time and/or the number of rotation of the circulation pump 62. The pump controller 80, for example, controls the circulation pump 62 to flow the ink I in the circulation path at a flow speed greater than 2 ml/min but less than 8 ml/min. The reason for flowing the ink I in the circulation path at such a flow speed is to shorten the time until the ink I, which has been sufficiently deaerated by the deaeration module 12, fills the third flow passage 93 and the ink reservoir 17 within a range where the meniscus of the nozzle row 16 of the head 11 is not broken by the pressure fluctuation caused by the pump 62.

FIG. 2 depicts the appearance of the head unit 10. As depicted in FIG. 2, the head unit 10 has a rectangular head unit housing 100. The top surface, the left side surface, and the right side surface of the head unit housing 100 are covered by a cover portion 100A. The head 11 is provided on the front surface of the head unit housing 100, and a nozzle protection cap 21 is attached to the head 11 when not performing printing operations.

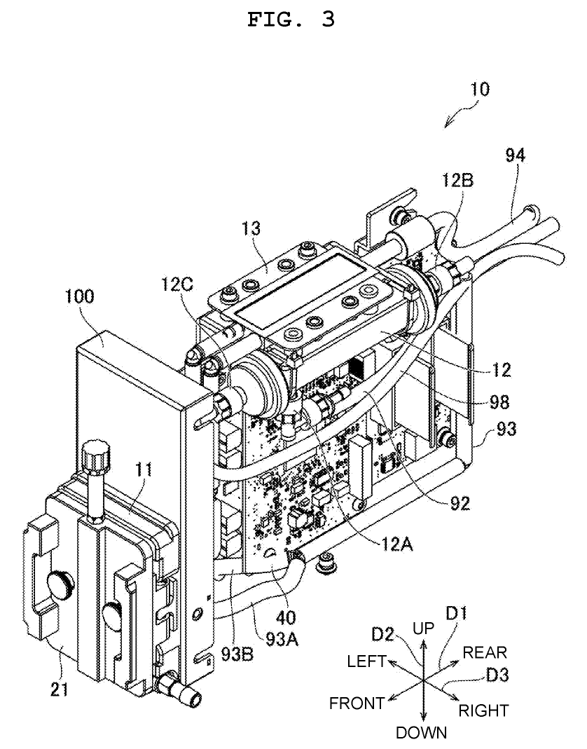

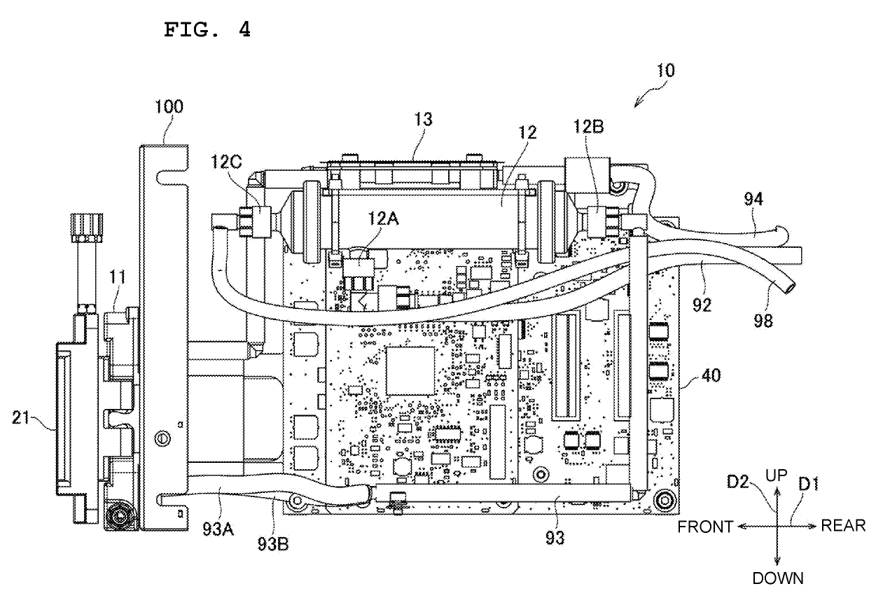

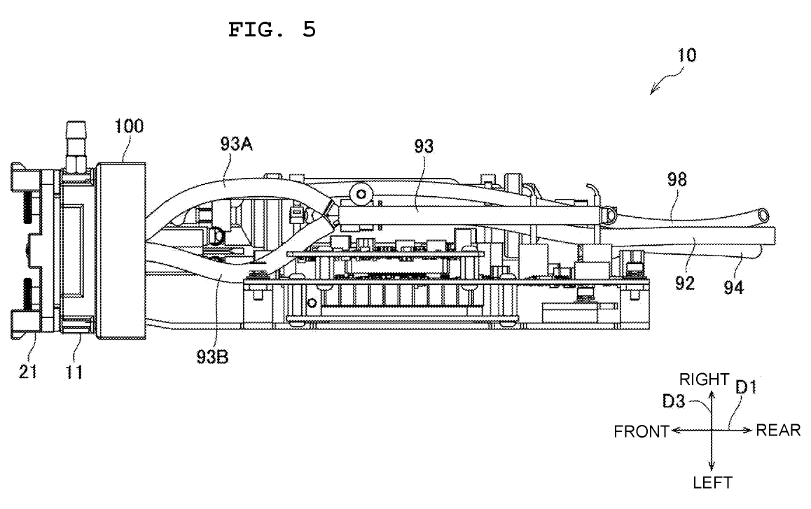

FIGS. 3 through 5 depict a state in which the cover section 100A is removed from the head unit 10 in FIG. 2. FIG. 3 is a perspective view, FIG. 4 is a right side view, and FIG. 5 is a bottom view. Referring to FIGS. 3 through 5, the following explains how the configurations included in the head unit 10 are arranged in the head unit housing 100.

The deaeration module 12 and the damper 13 are arranged in the head unit housing 100, avoiding the head 11 in a direction in which the nozzle rows 16 extend, that is, in the up-down direction. In other words, the deaeration module 12 and damper 13 do not overlap with the head 11 when viewed from the front-rear direction or from the left-right direction. Furthermore, the deaeration module 12 and damper 13 are arranged lying in the front-rear direction at an upper part inside the head unit housing 100. The reason for arranging them in this way is because the board 40 is erected at the bottom of the head unit housing 100, and it is necessary to avoid the board 40.

In addition, since the connection terminals on the board 40 and the head 11 are connected by a flexible cable (not depicted) that transmits the drive signals, the layout is arranged so as not to interfere with their routing. This layout facilitates assembly and maintenance of the head unit 10, and also prevents contamination of the electrical system in the event of ink leakage from the ink flow passage. Since the deaeration module 12 is longer than the head 11, the height of the head unit housing 100 to accommodate the deaeration module 12 becomes much larger than the length of the nozzle row 16 when the deaeration module 12 is arranged in the head unit 10 in an up-down direction. This would be undesirable because it would limit the environment in which the head unit 10 can be installed in relation to the printing target. Therefore, in order to reduce the size of the head unit housing 100 in this embodiment, the damper 13 that is thin in the up-down direction and extending in the front-rear direction is arranged above the deaeration module 12 and adjacent to the deaeration module 12. This reduces the size of the head unit housing 100 in the left-right direction and makes the head unit 10 smaller.

The deaeration module 12 has an ink inlet 12A, an ink outlet 12B, and a negative pressure supply port 12C. The ink inlet 12A is arranged at the bottom of the deaeration module 12 and in front of the central part of the front-rear direction. The ink outlet 12B is located at the rear of the deaeration module 12. The head unit 10 is designed to print either in a first printing mode, in which a recording medium located vertically is printed from the side, or in a second printing mode, in which a recording medium located horizontally is printed from the up.

When printing in the first printing mode, the head unit 10 is installed as depicted in FIG. 2, that is, the head unit 10 is installed so that its lower surface is horizontal and prints on the recording media facing the head 11. The ink inlet 12A is located at lower part of the deaeration module 12 and the ink outlet 12B is located at a rear part of the deaeration module 12 in order not to deteriorate the print quality when printing in the first printing mode. In other words, in a case where the ink inlet 12A is located at the lower part of the deaeration module 12, the ink I that flows into the deaeration module 12 fills the deaeration module 12 from the bottom, reaches the top, and flows out from the ink outlet 12B when the deaeration module 12 is full. When the ink I flows out of the deaeration module 12, the inside of the deaeration module 12 is filled with the ink I, and since no space is created, the path is not divided, and sufficiently deaerated ink I is supplied from the deaeration module 12 to the head 11. As a result, the sufficiently deaerated ink I is ejected from the head 11, thereby preventing deterioration of print quality.

On the other hand, when printing in the second printing mode, the head unit 10 is installed so that the front surface of the head unit 10 is horizontal and facing downward to print on the recording media facing the head 11. The reason why the ink inlet 12A is located forward of the center part of the front-rear direction of the deaeration module 12 and the ink outlet 12B is located at the rear part of the deaeration module 12 is to prevent deterioration of print quality when printing in the second printing mode. In other words, in a case where the ink inlet 12A is located forward of the center part of the front-rear direction, the ink I that flows into the deaeration module 12 fills the deaeration module 12 from the front part, reaches the rear part, and flows out from the ink outlet 12B when the deaeration module 12 is full. When the ink I flows out of the deaeration module 12, the inside of the deaeration module 12 is filled with the ink I, and since no space is created, the path is not divided, and sufficiently deaerated ink I is supplied from the deaeration module 12 to the head 11. As a result, the sufficiently deaerated ink I is ejected from the head 11, thereby preventing deterioration of print quality.

Thus, the ink inlet 12A is located at the lower part of the deaeration module 12 and i forward of the center part of the front-rear direction, and the ink outlet 12B is located at the rear part of the deaeration module 12, so that deterioration of printing quality can be suppressed when printing in either the first or second printing mode.

The second flow passage 92 is connected to the ink inlet 12A, the third flow passage 93 is connected to the ink outlet 12B, and the negative pressure path 98 is connected to the negative pressure supply port 12C. The third flow passage 93 is drawn along the rear and bottom surfaces of the head unit housing 100, and is split into two flow passages 93A and 93B in the middle, with one flow passage 93A connected to the ink flow passage 11A of one of the above two nozzle rows 16, and the other flow passage 93B connected to the other of the above two nozzle rows 16. The length of the third flow passage 93 should be shorter, and its flow passage diameter should be smaller to the extent that it does not impede the supply of the ink I for printing. This is because, as mentioned above, the amount of the ink I including dissolved gas and to be returned to the sub-tank 52 during the circulation-time process is decreased. In other words, if the amount of the ink I including dissolved gas and to be returned to the sub-tank 52 in the circulation-time process is small, the time from the start of the circulation-time process to the start of the print-time process will be shorter. For this reason, it is preferable to use the third flow passage 93, for example, with a path length of 500 mm or less and a flow passage diameter of 2 mm or more to 4 mm or less. However, because the path length must be up to the entire length of the deaeration module 12 due to the layout of the drawback, the flow passage length is, for example, 150 mm or longer in this embodiment.

As explained above, the inkjet recording apparatus 1 of this embodiment includes: a head 11 having a nozzle row 16 that eject ink I; a main tank 51 that stores the ink I; a first flow passage 91 through which the ink I flows from the main tank 51; a sub-tank 52 that is connected to the first flow passage 91 and temporarily stores the ink I flowed through the first flow passage 91; a second flow passage 92 through which the ink I flows from the sub-tank 52, a deaerator 30 connected to the second flow passage 92 for deaerating ink I flowing in the second flow passage 92; a third flow passage 93 through which the ink I deaerated by the deaerator 30 flows to the head 11; a fourth flow passage 94 connecting the head 11 to the sub-tank 52 and returning the ink I from head 11 to sub-tank 52; a circulation pump 62 applying pressure to a circulation path of the ink I including the sub-tank 52, the second flow passage 92, the deaerator 30, the third flow passage 93, the head 11, and the fourth flow passage 94 to create an ink flow of the ink I in the circulation path; and a damper 13 provided in the fourth flow passage 94 to control fluctuations in the pressure applied to the head 11.

The deaerator 30 has the ink inlet 12A and the ink outlet 12B. The ink inlet 12A is arranged closer to the head 11 than the ink outlet 12B in the direction of the ink I ejected from the nozzle row 16.

Thus, in this inkjet recording apparatus 1, the deaerator 30 is arranged downstream of the sub-tank, so that the ink amount in the flow passage connecting the deaerator 30 and the head 11 is small. Therefore, the time for the ink I deaerated by the deaerator 30 to reach the head 11 is shortened, and the initial printing time from a not printing state to a printing state can be further shortened. The deaerator 30 is arranged so that the ink inlet 12A thereof is closer to the head 11 than the ink outlet 12B in the direction in which the ink is ejected from the nozzle row 16. This suppresses the splitting of the ink path inside the deaeration module 12 during ink filling, thereby reducing ink supply problems.

The inkjet recording apparatus 1 has the head unit housing 100 and the ink supply unit housing 110. The deaerator 30 includes the deaeration module 12 having the ink flow passage through which the ink to be deaerated flows, and the negative pressure pump 63 to apply negative pressure to the deaeration module 12. The head unit housing 100 accommodates the head 11, the deaeration module 12, and the damper 13. The ink supply unit housing 110 accommodates the main tank 51, the sub-tank 52, the circulation pump 62, and the negative pressure pump 63. The head unit housing 100 and the ink supply unit housing 110 are connected via the cable 90 through which the second flow passage 92 and the fourth flow passage 94 pass.

Thus, in this inkjet recording apparatus 1, the head 11, the deaeration module 12, and the damper 13 are accommodated in the head unit housing 100, and the main tank 51, the sub tank 52, the circulation pump 62, and the negative pressure pump 63 are accommodated in the ink supply unit housing 110. In other words, the ejection of the ink I and the supply of the ink I are performed separately by the head unit housing 100 and the ink supply unit housing 110, and the head 11 and the deaeration module 12 are arranged close together in the head unit housing 100. This shortens the time for the ink I deaerated by the deaeration module 12 to reach the head 11, and thus makes it possible to further shorten the initial printing time from the not printing state to the printing state.

The deaeration module 12 and the damper 13 are arranged in the head unit housing 100 avoiding the head 11 in the direction in which the nozzle row 16 extends, in this embodiment, in the up-down direction. As a result, the deaeration module 12 and the damper 13 are arranged so as not to interfere with the flexible cable connecting the board 40 and the signal lines that drive the head 11. This leads to easier assembly and maintenance of the head unit 10, and also prevents the electrical system from being dirty in the event of ink leakage, etc. from the ink flow passage.

The deaeration module 12 and the damper 13 are arranged adjacent to each other in the head unit housing 100 in the direction in which the nozzle rows 16 extend, in this embodiment, in the up-down direction. This allows the deaeration module 12 and the damper 13 to be arranged efficiently in the space within the head unit housing 100 while avoiding the board 40. As a result, the size of the head unit housing 100 in the left-right direction can be reduced and the head unit 10 can be downsized.

The flow passage length of the third flow passage 93 is 500 mm or less, and the flow passage diameter of the third flow passage 93 is 2 mm or more and 4 mm or less. By defining the flow passage length and diameter of the third flow passage 93 in this way, the amount of the ink I containing a large amount of dissolved gas and staying in the third flow passage 93 can be limited. This makes it possible to reduce the amount of the ink I that is returned from the head 11 to the sub-tank 52.

The inkjet recording apparatus 1 also has the pump controller 80 that controls the operation of the circulation pump 62 and the negative pressure pump 63. The pump controller 80 drives the negative pressure pump 63 when the inkjet recorder 1 is turned on or before the recording operation by the head 11, and drives the circulation pump 62 after the negative pressure has been applied to the deaeration module 12 by the negative pressure pump 63 such that a predetermined amount of the ink I flows in the circulation path. The pump controller 80 controls the circulation pump 62 to stop while applying the negative pressure to the deaeration module 12 by the negative pressure pump 63.

Thus, only the predetermined amount of the ink I flows in the circulation path when the inkjet recording apparatus 1 is turned on or before the recording operation by the head 11, and no ink I flows in the circulation path during the recording operation by the head 11. Thus, the minimum amount of the ink I can be allowed to flow in the circulation path, when it is necessary to return the ink I from the head 11 to the sub-tank 52.

The predetermined amount is an ink amount of 1.0 to 1.2 times a total capacity of the third flow passage 93 and the head 11. This allows the minimum amount of the ink I to flow in the circulation path even when it is necessary to return the ink I from the head 11 to the sub-tank 52.

The inkjet recording apparatus 1 also includes the negative pressure path 98 connecting the negative pressure pump 63 and the deaeration module 12, and the check valve in the negative pressure path 98. The pump controller 80 controls the negative pressure pump 63 to stop when the negative pressure applied to the negative pressure path 98 by the negative pressure pump 63 reaches the target pressure. This allows a period of time during which the negative pressure pump 63 is in the stopped state, thereby reducing power consumption.

The pump controller 80 drives the circulation pump 62 while the negative pressure is applied to the deaeration module 12 such that the ink I flows in the circulation path at a flow speed greater than 2 ml/min and less than 8 ml/min. This allows the sufficiently deaerated ink to be supplied to the head 11 quickly, without causing nozzle meniscus break or other problems, and the printing operation can be started without making the user wait.

The present teaching is not limited to the above embodiments, but can be modified in various ways without departing from the intent.

(1) In the above embodiment, the pump controller 80 is provided inside the ink supply unit 50, but the pump controller 80 may be provided outside the ink supply unit 50. In this case, the pump controller 80 may be configured by a general-purpose apparatus such as a PC.

(2) In the above embodiment, the deaeration module 12 and the damper 13 are arranged lying in the front-rear direction at the upper part of the head unit housing 100, but if the board 40 is provided to be erected at the upper part of the head unit housing 100, the deaeration module 12 and the damper 13 may be arranged lying in the front-rear direction at a lower part of the head unit housing 100.

(3) In the above embodiment, the pump controller 80 started driving the negative pressure pump 63 at the start of the print-time process or the circulation-time process. The pump controller 80 may start driving the negative pressure pump 63 when the power of the inkjet recording apparatus 1 is turned on, and may drive the negative pressure pump 63 as necessary to maintain the negative pressure value in the negative pressure path 98 until the power is turned off.

What is claimed is:

1. An inkjet recording apparatus, comprising:
a head having a nozzle row configured to eject ink;
a main tank configured to store the ink;
a first flow passage through which the ink flows from the main tank;
a sub-tank connected to the first flow passage and configured to temporarily store the ink flowing in the first flow passage;
a second flow passage through which the ink flows from the sub-tank;
a deaerator connected to the second flow passage and configured to deaerate the ink flowing in the second flow passage;
a third flow passage through which the ink deaerated by the deaerator flows to the head;
a fourth flow passage connecting the head and the sub-tank, the ink being returned from the head to the sub-tank through the fourth flow passage;
a circulation pump configured to apply pressure to the ink in a circulation flow passage including the sub-tank, the second flow passage, the deaerator, the third flow passage, the head, and the fourth flow passage, to generate an ink flow of the ink in the circulation flow passage; and
a damper disposed in the fourth flow channel to control fluctuations in pressure applied to the head,
wherein the deaerator has an ink inlet and an ink outlet, and
the ink inlet is arranged closer to the head than the ink outlet in a direction in which the ink is ejected from the nozzle row.

2. The inkjet recording apparatus according to claim 1, further comprising:
a first housing; and
a second housing,
wherein the deaerator includes: a deaeration module with a flow passage through which the ink to be deaerated flows; and a negative pressure pump configured to apply negative pressure to the deaeration module,
the first housing accommodates the head, the deaeration module, and the damper,
the second housing accommodates the main tank, the sub-tank, the circulation pump, and the negative pressure pump, and
the first housing and the second housing are connected to each other via a cable through which the second flow passage and the fourth flow passage pass.

3. The inkjet recording apparatus according to claim 2, wherein the deaeration module and the damper are arranged in the first housing to avoid the head in a direction in which the nozzle row extends.

4. The inkjet recording apparatus according to claim 3, wherein the deaeration module and the damper are arranged adjacent to each other in the first housing in the direction in which the nozzle row extends.

5. The inkjet recording apparatus according to claim 1, wherein
a channel length of the third channel is 500 mm or less, and
a channel diameter of the third channel is 2 mm or more and 4 mm or less.

6. The inkjet recording apparatus according to claim 2, further comprising a pump controller configured to control driving of each of the circulation pump and the negative pressure pump,
wherein the pump controller is configured to:
drive the negative pressure pump when the inkjet recording apparatus is turned on or before a recording operation by the head, drive the circulation pump after the negative pressure pump has given negative pressure to the deaeration module, such that a predetermined amount of the ink flows in the circulation flow passage, and
stop the circulation pump with negative pressure being applied to the deaeration module by the negative pressure pump, during the recording operation by the head.

7. The inkjet recording apparatus according to claim 6, wherein the predetermined amount is an ink amount of 1.0 to 1.2 times a total capacity of the third flow passage and the head.

8. The inkjet recording apparatus according to claim 6, further comprising:
a negative pressure path connecting the negative pressure pump and the deaeration module; and
a check valve disposed in the negative pressure path,
wherein the pump controller is configured to stop the negative pressure pump in a case where the negative pressure given to the negative pressure path by the negative pressure pump reaches a target pressure.

9. The inkjet recording apparatus according to claim 6, wherein the pump controller is configured to control the circulation pump to drive with the negative pressure being applied to the deaeration module, such that the ink flows in the circulation flow passage at a flow speed greater than 2 ml/min and less than 8 ml/min.
